(19) United States
(12) Patent Application Publication
(10) Pub. No.: US 2017/0004416 A1
(43) Pub. Date: Jan. 5, 2017

(54) SYSTEMS AND METHODS FOR DETERMINING MACHINE INTELLIGENCE

(71) Applicant: Potomac Institute for Policy Studies, Arlington, VA (US)

(72) Inventors: Robert Hummel, Great Falls, VA (US); Michael Swetnam, Arlington, VA (US)

(73) Assignee: Potomac Institute for Policy Studies, Arlington, VA (US)

(21) Appl. No.: 15/198,942

(22) Filed: Jun. 30, 2016

Related U.S. Application Data
(60) Provisional application No. 62/307,047, filed on Mar. 11, 2016.
(60) Provisional application No. 62/186,782, filed on Jun. 30, 2015.

(51) Int. Cl. G06N 99/00; G06F 3/06

(52) U.S. Cl. CPC G06N 99/005; G06F 3/0604; G06F 3/0653; G06F 3/0673

(57) ABSTRACT

Systems and methods to determine machine intelligence are disclosed. Input information provided to a machine is evaluated via an interface with the machine. One or more operations automatically performed by the machine based on the input information are evaluated via the interface. A level of intelligence associated with the machine is determined based on the evaluation of the input information and the operations performed by the machine.

### CROSS-REFERENCE TO RELATED APPLICATIONS

This application claims priority to U.S. Provisional Application No. 62/186,782, entitled “SYSTEMS AND METHODS FOR DETERMINING MACHINE INTELLIGENCE,” filed on Jun. 30, 2015; and U.S. Provisional Patent Application No. 62/307,047, entitled “SYSTEMS AND METHODS FOR DETERMINING MACHINE INTELLIGENCE,” filed on Mar. 11, 2016, the disclosures of which are incorporated by reference herein in their entirety.

### TECHNICAL FIELD

The present invention relates to the field of artificial intelligence, and particularly to systems and methods for determining the intelligence of a machine, such as a computing device.

### BACKGROUND

Advances in machine intelligence continue to increase the computing capability or intelligence of machines. Many existing techniques of measuring machine intelligence do not truly measure a level of intelligence of a machine but rather assess the ability of the machine to mimic human behavior. For example, the Turing Test is an existing approach used in artificial intelligence to motivate and measure the performance of machine intelligence. The Turing test attempts to assess the ability of a machine to mimic human behavior. In the Turing test, a machine answers queries and responds to stimuli presented by examiners, and a measure is taken of the extent to which examiners are fooled into believing that the machine is human. The Turing test, however, may not motivate, nor test, systems that would build models of causation that constitute true knowledge or develop wisdom to influence outcomes from knowledge. Instead, the programs that have purported to succeed at passing the Turning test, or come close, have used “tricks” that attempt to mimic humans who are not truly knowledgeable. Consequently, the Turing Test and other existing metrics of machine intelligence do not provide a true measure of the intelligence of a machine.

### BRIEF SUMMARY OF THE INVENTION

Systems and methods to determine machine intelligence are disclosed. Input information provided to a machine is evaluated via an interface with the machine. One or more operations automatically performed by the machine based on the input information are evaluated via the interface. A level of intelligence associated with the machine is determined based on the evaluation of the input information and the operations performed by the machine.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 is a block diagram illustrating a system for determining machine intelligence according to embodiments of the present invention;

FIG. 2 is a flowchart illustrating a process for determining machine intelligence according to embodiments of the present invention;

FIG. 3 is a flowchart illustrating a process for determining a level of machine intelligence according to embodiments of the present invention;

FIG. 4 is a block diagram illustrating a process for determining that a machine includes data-level intelligence according to embodiments of the present invention;

FIG. 5 is a flowchart illustrating a process for determining that a machine includes data-level intelligence according to embodiments of the present invention;

FIG. 6 is a block diagram illustrating a process for determining that a machine includes information-level intelligence according to embodiments of the present invention;

FIG. 7 is a flowchart illustrating embodiments of a process for determining that a machine includes information-level intelligence according to embodiments of the present invention;

FIG. 8 is a block diagram illustrating a process for determining that a machine includes knowledge-level intelligence according to embodiments of the present invention;

FIG. 9 is a flowchart illustrating embodiments of a process for determining that a machine includes knowledge-level intelligence according to embodiments of the present invention;

FIG. 10 is a block diagram illustrating a process for determining that a machine includes wisdom-level intelligence according to embodiments of the present invention; and

FIG. 11 is a flowchart illustrating embodiments of a process for determining that a machine includes wisdom-level intelligence according to embodiments of the present invention.

### DETAILED DESCRIPTION OF THE INVENTION

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be” and the like, are meant to include, but not be limited to, the listed examples.

Determining machine intelligence is disclosed. The techniques disclosed herein determine if a machine exhibits intelligent behavior. In contrast to existing approaches providing a measure of intelligence on a continuous single-dimensional scale of an intelligence property, the techniques disclosed herein define discrete levels of intelligence, and provide a way to determine at what level of intelligence a machine is operating. The discrete levels may be defined, for example, according to mathematical formulations that provide distinctions between the levels.

In some embodiments, a maximum level at which a machine intelligence operates may be determined. It may be determined, for example, whether a machine is operating at a Level 0, Level 1, Level 2, or Level 3 intelligence. In certain cases, it may be determined whether a machine is operating at a data-level, information-level, knowledge-level, or wisdom-level of intelligence.

In various embodiments, a questions format, such a “20 questions” format, is used to determine a level at which a system operates, such as Data, Information, Knowledge, or Wisdom level. This test may not necessarily provide for a measure within the level, but just the highest level of attainment for a system capable of intelligence. In certain cases, the system may be required to pass certain questions at a given level, and that for other questions, one or more of a groups must be satisfied. By assigning points to each question, and then scoring the system at each given level, it can be determined if the system has truly attained that level of intelligence, while still allowing for some ambiguity and “partial credit” in some of the questions.

An intelligent system can operate at a Data Level, an Information Level, a Knowledge Level, or a Wisdom Level (or none of the above), which may be referred to as D, I, K, and W levels. If it operates at an I-level, then it also either operates at or uses a system that operates at the D level. Similarly, a K-level system is also, or uses, an I- and D-level system, and a W level system is also, or uses, K-, I-, and D-level systems.

In various embodiments, a system purporting to operate at D-level may be evaluated using one or more of the following questions:

1. Does the system receive inputs that are measurements (data)? (20 points)

2. Does the system insert those measurements into a store of data? (20 points)

3. Does the store of data have permanence, such that it can be appended or reviewed later? (20 points)

4. Does the permit subsequent use of that store of data? (20 points)

5. Can database operations be executed on that store of data? (20 points)

In certain cases, if a system scores 90 or higher (allowing for some ambiguity in the scores for answers to questions), then the system is at least a D-level system.

In various embodiments, a system purporting to operate at I-level may be evaluated using one or more of the following questions:

1. Does the system permit queries that request information? (25 points)

2. Does the system access multiple elements of a data store in order to answer the query? (25 points)

3. Does the system find trends in the data and output information about those trends? (10 points)

4. Does the system find statistics concerning the data and use those statistics to provide information? (10 points)

5. Does the system correlate data across the data store, or find correlations among the elements in the data store? (10 points)

6. Can the system predict data that would be measured for a system that interpolates between states of the system for which data has been collected? (10 points)

7. Does the system combine data from more than one database? (10 points)

In certain cases, If the system scores greater than 80, then it is at least an I-level system.

In various embodiments, a system purporting to operate at K-level may be evaluated using one or more of the following questions:

1. Does the system ingest or build information about a system? (20 points)

2. Does the system build a model of that system, such that the model depends on the information that the system receives? (20 pints)

3. Does the model include a model of causality that explains how the system works or evolves in response to its inputs? (10 points)

4. Can the model provide useful predictions of information about the system that it models? (10 points)

5. Does the model include a set of values that corresponds to a notion of the state of the system that is being modeled? (10 points)

6. Does the model explain most of the information that is provided about the system? (10 points)

7. Does the model permit the prediction of information that extrapolates from the observed behavior of the system on which the input information was based? (10 points)

8. Does the model provide information about the structure of the system, including elements that cannot be directly observed and are thus not part of the input information? (5 points)

9. Can the system build models about different systems, based on input information about each such system? (5 points)

In certain instances, if the scores greater than 80, then it is at least a K-level system.

In various embodiments, a system purporting to operate at W-level may be evaluated using one or more of the following questions:

1. Does the system ingest multiple models that model a compound system, where each one models either all or part of the system (i.e., a subsystem)? (20 points)

2. Does the system build a model (a meta-model) of a system that varies if any of the ingested models varies? (20 points)

3. Can the system change one or more of the ingested models, to thereby change the output meta-model (in a what-if experiment)? (10 points)

4. Does the system use the meta-model to explore possible states of the modeled system, under various hypothetical circumstances (states)? (10 points)

5. Does the system use the meta-model to explore possible states of the modeled system by varying ingested models? (10 points)

6. Does the system use the meta-model to explore possible states and to attempt to maximize a metric applied to the information provided by the meta-model? (10 points)

7. Does the system provide information about how the system might be changed so as to provide different (and better) states, according to some metric? (10 points)

8. If so, is that information actionable, in that controllable parameters of the system could be changed so as to conform to the different and better state of the system, as predicted by the meta-model? (10 points)

In some cases, if the system scores greater than 80, then it is a W-level system.

In some embodiments, the techniques disclosed herein evaluate discrete levels of intelligence. However, within a given level, there may be measurable degrees (or a continuum of degrees) of intelligence at that level.

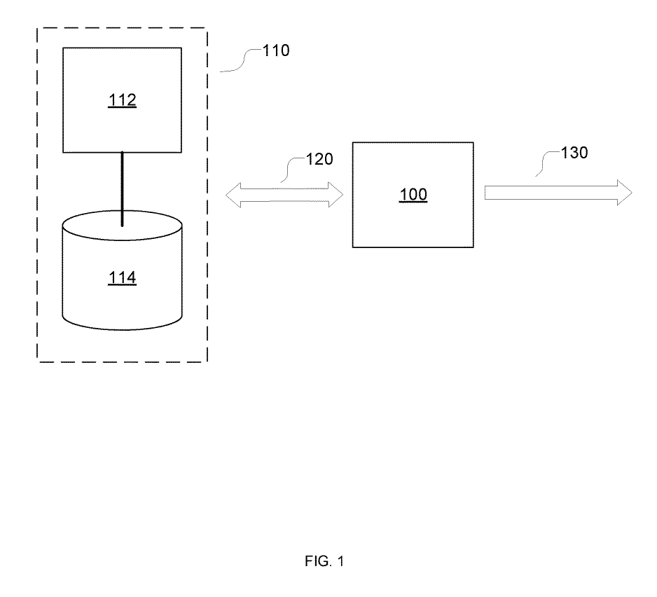

FIG. 1 is a block diagram illustrating a system for determining machine intelligence according to embodiments of the present invention. In the example shown, a system 100 for determining machine intelligence receives input from and/or provides information to a machine 110. The system 100 for determining machine intelligence may receive information/data from and provide information/data to the machine 110 via an interface 120. Based on information/data received from and provided to the machine 110, the system 100 for determining machine intelligence determines a level of intelligence associated with the machine 110. The level of intelligence may be provided as output 130 from the system 100.

A system 100 for determining machine intelligence may include, for example, a computer, a program, a compiler, an algorithm, a software program, and/or other module. The system 100 may include, for example, a computer separate from the machine 110 and connected to the machine via an interface 120. In certain cases, the system 100 may include a module associated with the machine 110, such as a program running on the machine 110 and/or a module interfaced with machine 110. In another example, the system 100 may include both component(s) separate from the machine 110 and component(s) include in the machine 110.

A machine 110 as disclosed herein may include a broader set of items than the traditional meaning of the term machine. A machine 110 may include, for example, any type of object, system, device, living organism, and/or thing that interacts with information. The machine 110 may include, for example, a computer, server, system, module, node, software program, algorithm, process, mechanical computing device, biological computing device, quantum computing device, and/or any other device that processes information. In one example, the machine 110 includes a computer comprising a processor 112, a memory 114, and/or other components. The machine 110 may alternatively include a program executed on a computing device. In other instances, the machine 110 may include system including unknown functionality. The machine 110 may, for example, include a “black box”.

The interface 120 may include, for example, a compiler-based interface, an application programming interface (API), a physical interface (such as, wire connection, a wire bus), and/or any other type of interface. In certain cases, the system 100 and/or interface 120 may include a compiler and/or operate similar to a compiler. In one example, the system 100 and/or interface 120 may operate as a compiler where the output of the compiler is a declaration of a level of machine intelligence (a level of intelligence at which the machine 110 operates).

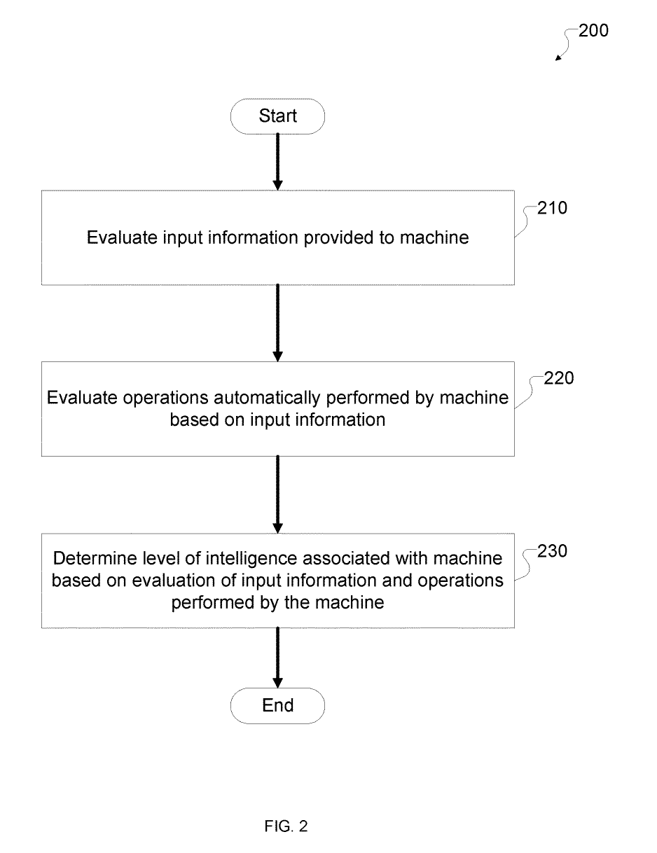

FIG. 2 is a flowchart illustrating embodiments of a process for determining machine intelligence according to embodiments of the present invention. In various embodiments, the process 200 of FIG. 2 may be implemented in system 100 of FIG. 1. Variations of the process 200 disclosed in FIG. 2 may be used to evaluate whether a machine satisfies the requirements and/or matches the patterns for various levels of machine intelligence, such as data-level, information-level, knowledge-level, wisdom-level, and/or another level of intelligence.

In the example shown, input information provided to a machine is evaluated (210) via an interface to the machine. In certain cases, input information may be provided from a system (such as, system 100 of FIG. 1) evaluating the intelligence of the machine to the machine. In other cases, the machine may receive the input information from other sources and/or the input information may be generated by the machine itself In various embodiments, evaluating the input information may include identifying the input information and/or a type of input information provided to the machine.

In some embodiments, a type of input information evaluated may depend, for example, on a level of machine intelligence being evaluated. In the event a machine is being evaluated for data-level intelligence, the input information may include data, such as measurements, input to the machine. In the event a machine is being evaluated for information-level intelligence, the input information may include one or more queries to the machine. In the event a machine is being evaluated for knowledge-level intelligence, the input information may include information about a system (such as a system separate from system 100 of FIG. 1). In the event a machine is being evaluated for wisdom-level intelligence, the input information may include multiple models that model a compound system (such as a system separate from system 100 of FIG. 1). Each of the models may model either all or a part of the system (i.e., a subsystem).

Operations automatically performed by the machine based on the input information are evaluated (220). The operations automatically performed by the machine may be evaluated via the interface with the machine (such as an interface associated with a compiler-based system). The operations evaluated may depend, for example, on a level of machine intelligence being evaluated. In the event a machine is being evaluated for data level intelligence, it may be determined whether the machine performs and/or is configured to perform operations such as automatically inserting input information (such as measurements (data)) into a store of data and/or other operations. In the event a machine is being evaluated for information-level intelligence, it may be determined whether the machine performs and/or is configured to perform operations such as retrieving two or more distinct sets of information from memory based on the input information (such as quer(ies)), generating output based on the input information and the distinct sets of information retrieved from memory, and/or other operations. In the event a machine is being evaluated for knowledge-level intelligence, it may be determined whether the machine performs and/or is configured to perform operations such as generating a model based on input information associated with a system (such as a system separate from system 100 of FIG. 1), using the model to make predictions about the system based, for example, on state information of the system, and/or other operations. In the event a machine is being evaluated for wisdom-level intelligence, it may be determined whether the machine performs and/or is configured to perform operations such as generating a meta-model based on multiple models associated with a compound system, modifying models to change the output of the meta-model, using the model to predict states of the compound system, and/or other operations. The above examples include a subset of the types of operations, and additional example operations are discussed in detail below and/or would be apparent to those skilled in the art.

A level of intelligence associated with the machine is determined (230) based on the evaluation of the input information and the operations automatically performed by the machine. For example, the output and/or results of operations performed based on the input information may be evaluated to determine whether the machine meets the requirements and/or pattern of behavior associated with a particular level of machine intelligence. In some embodiments, operations performed by the machine and/or operations the machine is configured to perform based on the input information are evaluated to determine whether the machine matches one or more patterns associated with a particular level of intelligence.

In some cases, a score may be generated based on a number of different types of operations (e.g., non-routine computer operations) a machine is observed to perform based on input information. For example, each operation may be associated with a score, and if the machine is observed to perform that operation, the value of that score may be added to total score associated with that machine. The total score associated with a machine may be compared to a threshold score, and if the score for the machine exceeds the threshold it may be determined that the machine is operating at that level of intelligence.

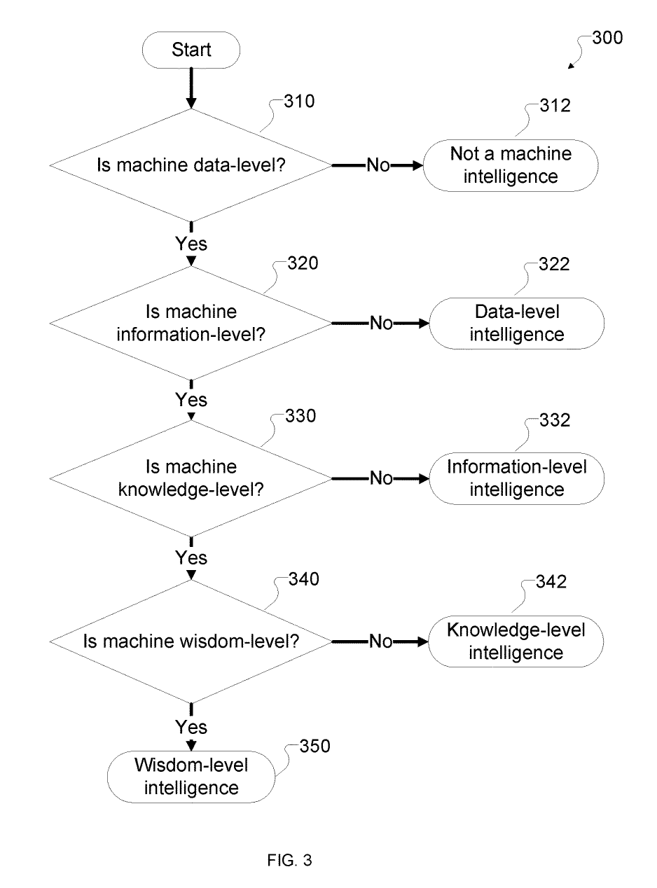

FIG. 3 is a flowchart illustrating embodiments of a process for determining machine intelligence according to embodiments of the present invention. In various embodiments, the process 300 of FIG. 3 may be implemented in system 100 of FIG. 1. Process 300 may include a test to determine a level of intelligence associated with a machine. The process 300 (test) may include one or more sub-processes 310, 320, 330, 340 (sub-tests). In certain cases, each one or more of the sub-tests 310, 320, 330, 340 are performed according to a variation of the process 200 of FIG. 2.

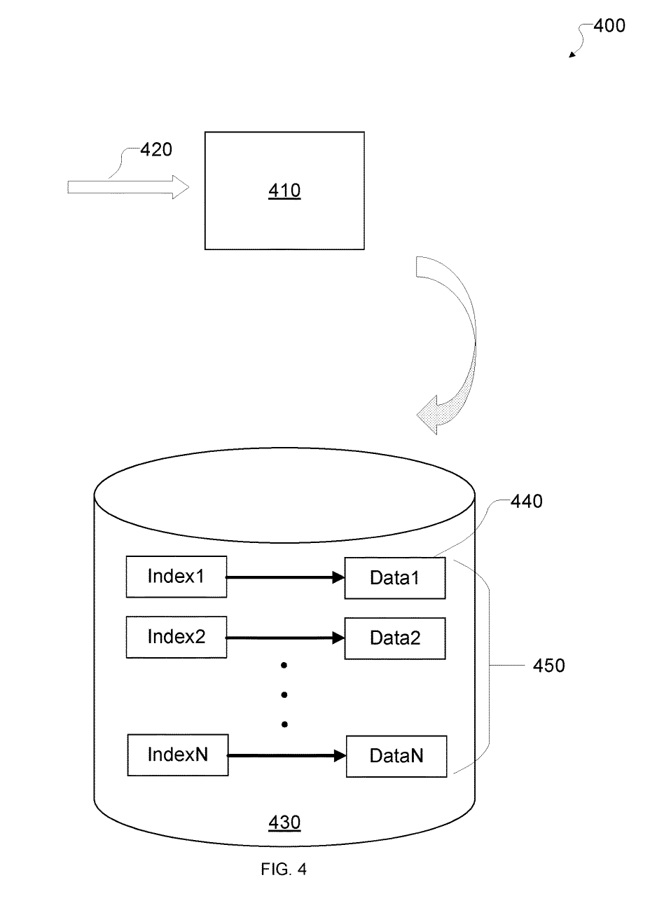

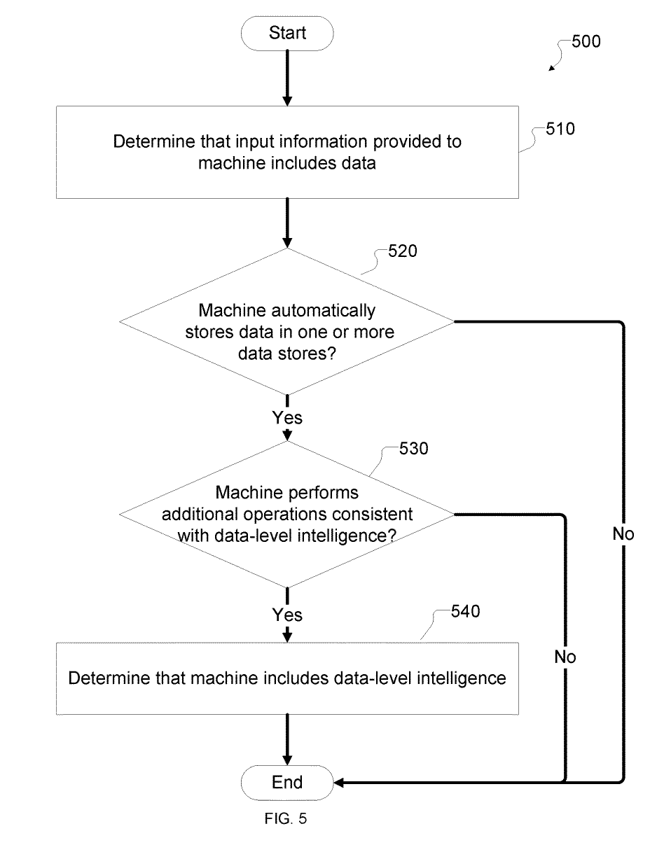

At 310, it is determined whether a machine operates at a data-level. In one example, processes 400, 500 as depicted in FIG. 4 and FIG. 5 and associated description are performed to determine whether a machine operates at data level. In the event it is determined that the machine does not operate at a data level, the process proceeds to step 312, and it is determined that machine does not include intelligence. In the event it is determined that the machine operates at a data level, the process proceeds to step 320.

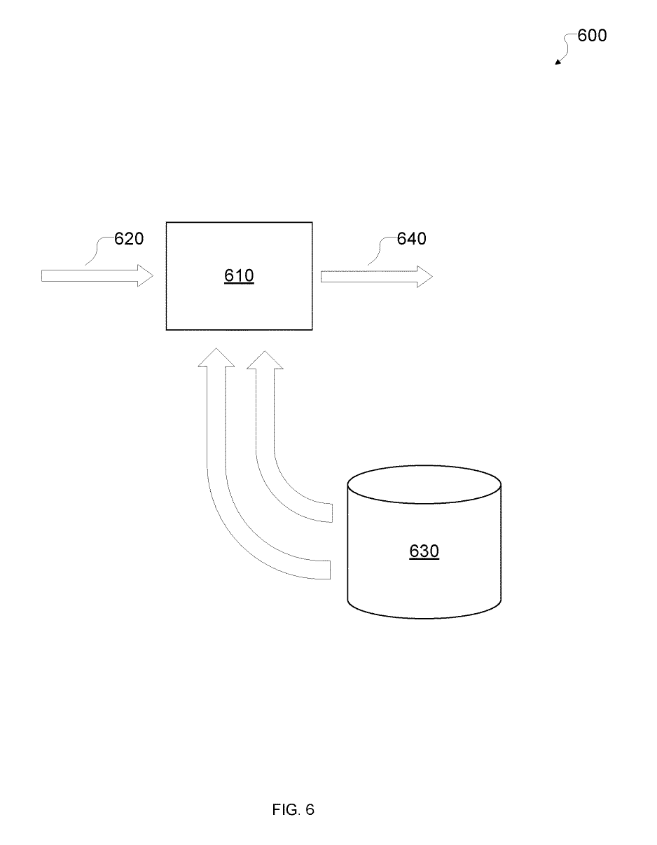

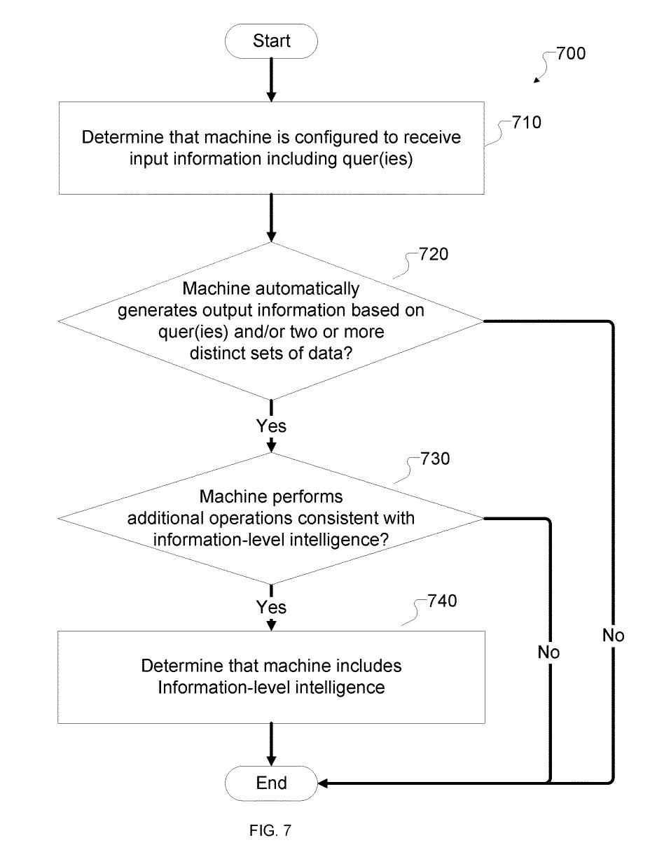

At step 320, it is determined whether the machine operates at an information level. In certain examples, processes 600, 700 as depicted in FIG. 6 and FIG. 7 and associated description are performed to determine whether a machine operates at an information level. In the event it is determined that the machine does not operate at an information level, the process proceeds to step 322 and it is determined that machine operates at a data level and/or includes data-level intelligence. In the event it is determined that the machine operates at an information level, the process proceeds to step 330.

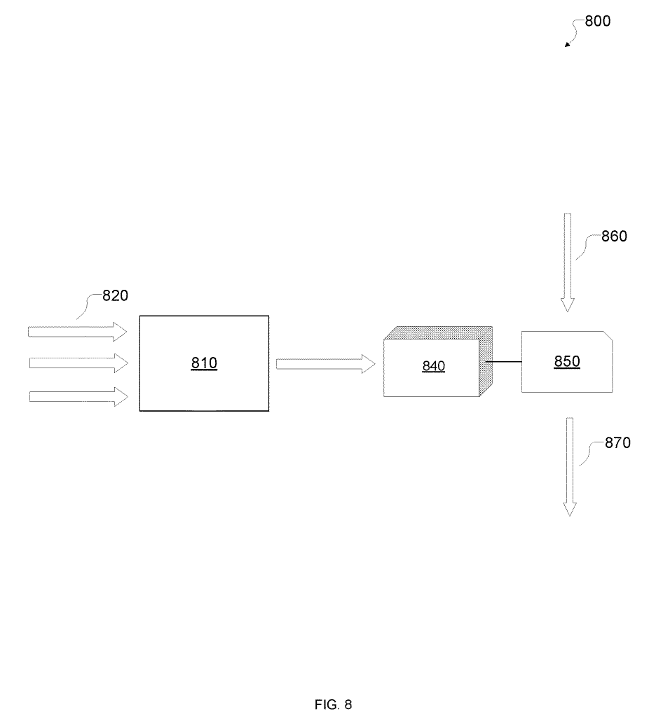

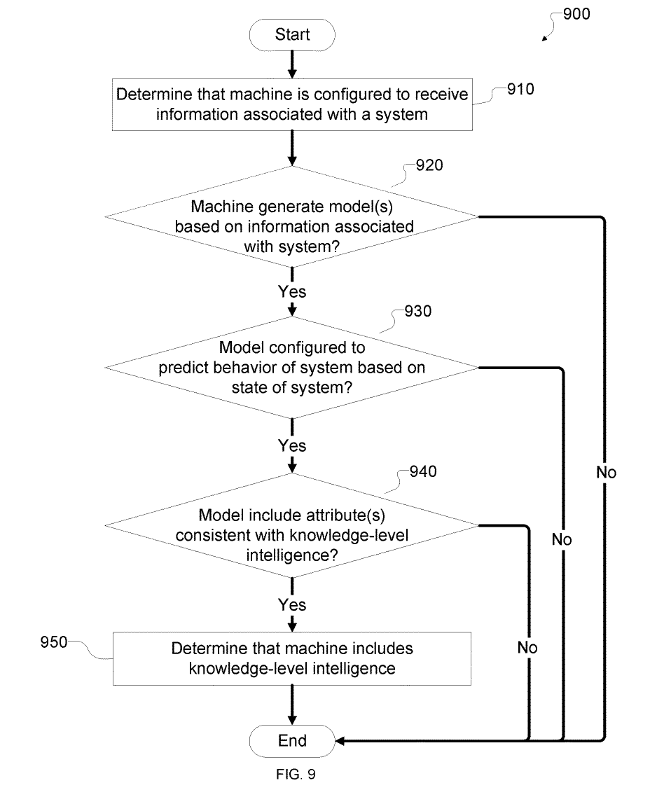

At step 330, it is determined whether the machine operates at a knowledge level. In certain examples, processes 800, 900 as depicted in FIG. 8 and FIG. 9 and the associated description are performed to determine whether the machine operates at a knowledge level. In the event it is determined that the machine does not operate at a knowledge level, the process proceeds to step 332 and it is determined that machine operates at an information level and/or includes information-level intelligence. In the event it is determined that the machine operates at an information level, the process proceeds to step 340.

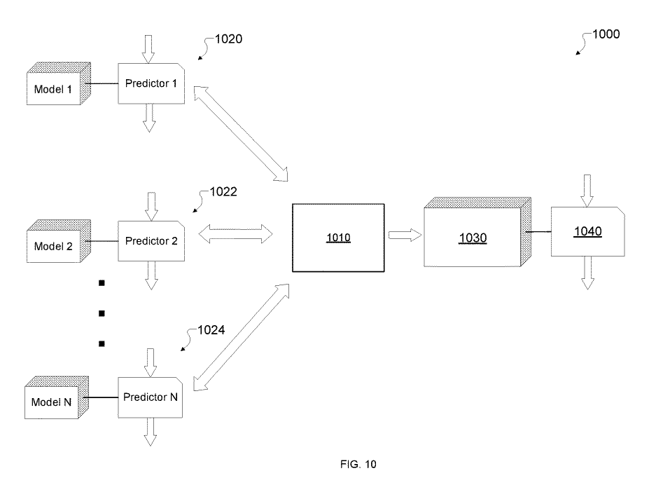

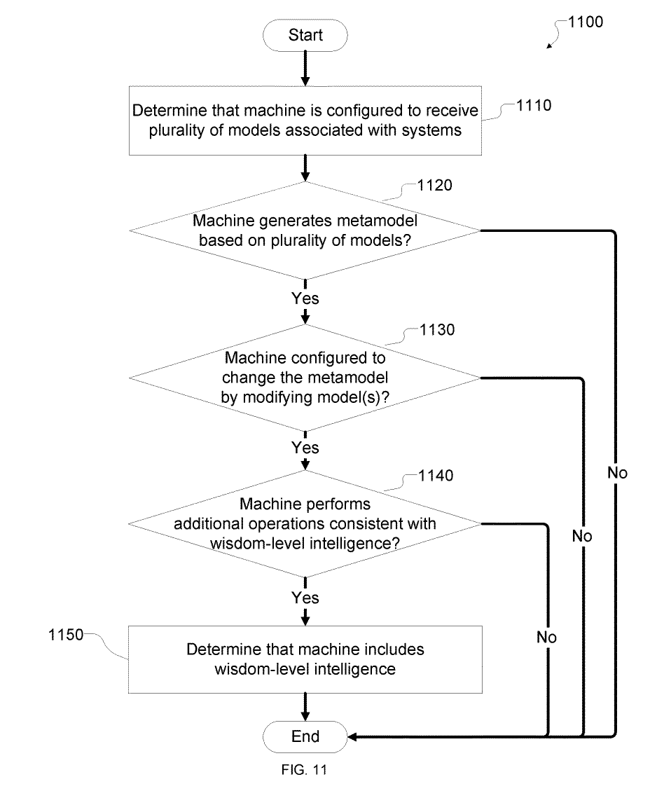

At step 340, it is determined whether the machine operates at a wisdom level. In certain examples, processes 1000, 1100 as depicted in FIG. 10 and FIG. 11 and the associated description are performed to determine whether the machine operates at a wisdom level. In the event it is determined that the machine does not operate at a wisdom level, the process proceeds to step 342 and it is determined that machine operates at a knowledge level and/or includes knowledge-level intelligence. In the event it is determined that the machine operates at a wisdom level, the process proceeds to step 350.

At step 350, it is determined that the machine operates at a wisdom level. In certain cases, additional tests may be performed to assess other aspects of the machine.

The process 300 of determining machine intelligence illustrates an embodiment where levels of intelligence are evaluated in series (e.g., the data level sub-test 310 is performed, then the information level sub-test 320, and so on). In some embodiments (not shown), sub-tests 310, 320, 330, 340 are performed independently of one another, in parallel, and/or in another manner. In this case, the machine passes one or more of the sub-tests, and the machine may be classified according to the highest level sub-test that is satisfies.

FIG. 4 is block diagram illustrating a process for determining that a machine includes data-level intelligence according to embodiments of the present invention.

In various embodiments. A machine may embody data-level intelligence, for example, if the machine automatically collects and stores data in a form that can later be organized and used. Data level intelligence may include recording, storing, and recalling sensory inputs from the system. Data may include the signals coming into a system that can be detected, stored, and processed. Data may include a process that results in a set of numbers or values that are the measurements or recordings of sensory input. For example, data may include a collection of bits, numbers, or recorded “things” that have associations to their source, which is the surrounding system. Temperature readings of a system might provide measurements that are noisy and thus estimates of a “true temperature;” they constitute the fact that the data given by the sensor system (e.g., the thermometer) is recorded at a particular point in time and subject to particular conditions. When digitized, the data can be stored using bits, together with information about the time and source, and potentially additional information about error brackets, bounds, accuracy, and other parameters. Data may also include text, or descriptions, in an unstructured format. The collection of data need not be particularly well organized.

In process 400, a system for determining machine intelligence (for example, system 100 of FIG. 1) may verify that a machine 410 operates at a data-level intelligence. It may be determined that the machine 410, at a minimum, collects and/or stores input information 420, such as measurements (data), into one or more databases 430. In some embodiments, it is determined whether the database 430 is available for use either in a single sustained execution of the machine 410, or in subsequent executions of the machine 410 and/or some other program. In certain cases, the machine 410 is evaluated to determine whether it operates according to a pattern where input information 420 is received, and then inserted into a database 430 that is stored. For example, it may be determined that the machine 410 automatically inserts data into the database 430 based on inputs to the machine 410. In some cases, the database operations performed by the machine 410 are evaluated. It may be determined whether the machine 410 makes use of the database 430 by, for example, inserting data in the database 430 based on the input information 420 received by the machine 410, in which case the machine 410 is operating at the data level (or higher).

In various embodiments, it may be determined whether the machine 410 is configured to access individual elements 440 in an input dataset 450. This can be verified by running an information retrieval task, to determine if the machine 410 is configured to execute such a task. In certain cases, a machine 410 can still pass the test by verifying that internal to the machine's programming, it is able to access and process, in some form, individual data elements 440. An individual data element 440 may include an element in a dataset 450, where the dataset 450 is based on an input 420 to the machine 410. A dataset 450 may include a mapping from a finite discrete domain to output values, which are measurements, documents, and/or other elements that can, for example, be represented in computer memory. In certain cases, a dataset 450 may include a finite set of tuples, where the first element in each tuple includes a domain value, and the second element includes the output. The domain values may be unique. It suffices for the machine 410 to return a pointer to a data value in response to a query, as this proves that it would be capable of accessing that value. A search engine may, for example, operate at a data level, at a minimum, since a search engine returns a pointer to a document in a dataset of all indexed documents.

In some embodiments, each operation a machine 410 is capable of performing may be associated with a score, and if the score associated with the machine 410 is above a threshold, it is determined that the machine 410 operates at a data level. For example, a determination that input information 420 provided to a machine includes data (measurements) may equate to 20 points; a determination that input information 420 is automatically stored in one or more data storages 430 may equate to 20 points; a determination that the machine 410 stores data in a store of data 430 that has permanence, such that it can be appended or reviewed later, may equate to 20 points; a determination that the machine 410 is configured to permit subsequent use of that store of data 430 may equate to 20 points; and/or a determination that the machine 410 can execute database operations on the store of data 430 may equate to 20 points. If the machine 410, for example, scores 90 or higher, then the machine 410 may be determined to be at least a data-level system. In certain cases, there may be some allowance for ambiguity in the scores by, for example, allowing partial credit.

FIG. 5 is a flowchart illustrating embodiments of a process for determining that a machine includes data-level intelligence according to embodiments of the present invention. Information may result from an application of a process to a dataset (or multiple datasets), which establishes a relationship among various pieces data, such as a correlation or average. Information may be derived from data, and may not necessarily be based on direct measurements. Information may represent new understanding based on relationships among data elements. For example, such relationships might be provided by a regression of numerical values, or a retrieval of a record based on specific criteria, or a statistical database operation that combines more than one datum. For text data, information might be a summary or synopsis developed from the data, or an explanation that comes from combining text data with other data or other information. Often information comes from finding relationships between different sets of data that are combined.

Information can be created, since a body of data is absorbed. Information may include patterns/trends in a dataset, and not necessarily a single piece of data. Thus information describes constraints on the data. Information includes a certain level of predictive power, gained from understanding data. Whereas data may have minimal interpretative power, and hence may not include intelligence, information begins the process of moving up an intelligence hierarchy, by virtue of examining a body of data in the context of a question or other data.

Information may include a collection of functions together with the set of data points, or output values. For example, the average value of the data set is the result of a function that evaluates the average. Both pieces (the averaging function and the data set being averaged) provide less understanding of the system than the information of the average of the data set. Other functions might perform a linear regression and provide the parameters of that regression; another function might describe the data as following an approximate exponential growth pattern. It is the functional that codifies the information, which describes the trends in the data, or a specific operation applied to the data together with the resultant value.

Information retrieval, for example, may occur based on evaluation of an entire database, together with the resultant extracted results. Information may include a higher level than data, and can be distinguished by the fact that it specifies constraints, patterns, or statistics about data.

In various embodiments, process 500 may be implemented by system 100 of FIG. 1. The process 500 may be used to determine whether a machine includes and/or operates with data-level intelligence. A machine may embody data-level intelligence, for example, if the machine automatically collects and stores data in a form that can later be organized and used.

At 510, it is determined that input information provided to a machine includes data. Input information to a machine may be evaluated to determine whether the input information includes data, such as data comprising measurements or measurement data. In some embodiments, data includes set of numbers or values, where the values have to do with measurements provided by systems. Data may include, for example, a collection of bits, numbers, and/or recorded “things” that have associations to their source, an object, and/or event. In one example, digital data may include the 1's and 0's of computer language that serve to create computations. In another example, data may include numerical values, such as temperature readings that are sensed by a thermometer, and subsequently collected and stored in a database.

At 520, it is determined whether the input information (data) is automatically stored in one or more data stores. It may be determined, for example, whether a machine automatically inserts data into a database based on inputs to the machine. In the event the machine is configured to automatically store data in one or more storages, the process proceeds to step 530. In the event it is determined that the machine is not configured to automatically store data, the process may end and it is determined that the machine does not operate with data-level intelligence.

At 530, it may be determined whether the machine is configured to perform other operations consistent with a device operating with data-level intelligence. By way of example, it may be determined whether the machine stores data in a store of data that has permanence, such that it can be appended or reviewed later. In a further example, it may also be determined whether the machine is configured to permit subsequent use of that store of data. In another example, it is determined whether the machine can execute database operations on the store of data. In the event the machine is configured to perform operation(s) consistent with data level intelligence, the process proceeds to step 540. In the event the machine is not configured to perform operation(s) consistent with data level intelligence, the process may end and it is determined that the machine does not operate with data-level intelligence.

At 540, it is determined that the machine includes data-level intelligence. Upon a determination that a machine includes data-level intelligence, the machine may be evaluated for information-level and/or other levels of intelligence.

FIG. 6 is block diagram illustrating a process for determining that a machine includes information-level intelligence according to embodiments of the present invention. Knowledge may involve formulation of a model, which extrapolates beyond the experiences in the observed data, by providing a causal explanation of the data. The data may provide the observables (e.g., measurements) taken from the system, but the model of the system attempts to explain how the system works, and thus should be consistent with the data, but also extrapolate from it. Knowledge may predict what the data might look like in other kinds of situations.

Knowledge may be distinct from information in that the model of understanding of the system can hypothesize causation and underlying structure to explain the behavior. A knowledge model may be more complex than a simple functional relationship. It may relate to a larger number of variables. For example, a linear regression of data, while a primitive model that includes a few parameters, does not explain causation at any level, since the relationship between the data elements is correlative rather than causative. There are many examples of correlation that have nothing to do with causation. Correlation provides a global structure, but not an underlying constituent structure. Models provide an understanding of underlying structures and the ability to predict data that have never been experienced.

Much research and development in “Big Data” is focused on developing machines (e.g., computers) that can obtain higher-levels of intelligence. One aspect in achieving this is a machine's ability to create models. Evaluating knowledge level intelligence may include considering the constituent components of a model. A model may include something that explains how inputs, or the state of the system, are related to the predicted outputs or progression of the system. A model may predict the behavior of the system in cases that extrapolate from observed data, or observed experience. Models may go beyond being a set of correlations to identify causation. A model is often the hypothesis, and is validated through experimentation that verifies the predictions outside of the range of existing experience.

Models must be useful for predictions, particularly beyond observed phenomena. But models are often refined as more data becomes available and experiments show discrepancies, however minor, from the existing model. A model include an approximation up until the time that it is refined so as to provide a better approximation. It provides predictions that can be used to understand why things behave the way they do, and to predict how things might behave in other circumstances. To operate at the Knowledge level, a model needs to be useful and it needs to be able to iteratively change when it accumulates new data.

In process 600, a system for determining machine intelligence (for example, system 100 of FIG. 1) may verify that a machine 610 operates at an information-level intelligence. In various embodiments, it is determined whether the machine 610 is configured to receive input information 620 including queries that request information. It is determined whether the machine 610 accesses multiple elements of a data store 630 to answer, respond, and/or otherwise generate output 640 in response to the query. If the machine 610 combines data from multiple parts of a data store 630 (database), combines input information 620 (e.g., quer(ies)) and data from a data store 630, and/or combines data from more than one database to generate output 640 dependent on the input information 620, the machine 610 may be determined to be operating at an information-level of intelligence. Output 640 may include, for example, parameters and/or values that describe the data or portions of the data retrieved from the plurality of data storage locations.

In some embodiments, if the machine 610 uses data to find trends and/or to interpret the data in response to a query 620, then it is providing output information 640 and operating at the information-level of intelligence. For example, it may be determined whether the machine 610 observes patterns and/or constraints among elements of a dataset, which can be expressed as constraints and/or approximate constraints. In certain cases, this can be a database operation that joins two or more elements, or an operation that finds a relationship between two or more elements.

According to some embodiments, it may be determined that the machine 610 is operating at an information level if the machine 610 outputs information 640 in response to a query 620. If, for example, the output information 640 provided by the machine 610 depends on more than one data element in the data store 630 and describes something about that subset of data elements, the machine 610 may be determined to be operating at an information level. In some embodiments, a machine 610 may be operating at the information level regardless of whether information is output. For example, the machine 610 may use information that it gleans from the dataset to, for example, to make predictions based on current circumstances, and this case the machine 610 may be operating at an information-level intelligence. To verify that the machine is operating at the information level, it may suffice to verify that the internals of the machine 610 are using information obtained from the dataset(s) 630 in order to make predictions.

In some embodiments, each operation a machine 610 is capable of performing may be associated with a score, and if the score associated with the machine 610 is above a threshold, it is determined that the machine operates at an information level. For example, a determination that the machine 610 is configured to receive queries 620 that request information may equate to 25 points; a determination that the machine 610 is configured to access multiple elements of a data store 630 (e.g., one or more databases, memories, etc.) in order to answer the query 620 may equate to 25 points; a determination that machine is configured to find trends in the data and output information 640 associated with the trends may equate to 10 points; a determination that the machine 610 finds statistics associated with data retrieved from one or more data stores 630 and uses those statistics to provide information 640 may equate to 10 points; a determination that the machine 610 correlates data across the data store 630 and/or determines correlations among the elements in the data store 630 may equate to 10 points; a determination that the machine 610 is configured to predict data that would be measured for a system that interpolates between states of the system for which data has been collected may equate to 10 points; and a determination that the machine 610 combines data from more than one database 630 may equate to 10 points. If the machine 610, for example, scores 80 or higher, then the machine 610 may be determined to be at least an information-level system.

FIG. 7 is a flowchart illustrating embodiments of a process for determining that a machine includes information-level intelligence according to embodiments of the present invention. In various embodiments, process 700 may be implemented by system 100 of FIG. 1. The process 700 may be used to determine whether a machine includes and/or operates with information-level intelligence.

At 710, it is determined that the machine is configured to receive input information including one or more queries. In certain cases, input information provided to the machine may, for example, be evaluated by a system for determining machine intelligence, and based on the evaluation it may be determined that the machine is configured to receive quer(ies) requesting information. In some instances, a system evaluating machine intelligence may provide the queries to the machine.

At 720, it is determined whether the machine is configured to automatically generate output information based on the quer(ies) and/or two or more distinct sets of data. In some instances, it may be determined whether the machine accesses multiple elements of a data store to retrieve distinct sets of data responsive to the query. It is then determined whether the machine generates output information by, for example, combining the distinct sets of data and/or the query information. The machine may generate output information, for example, based on trends and/or patterns associated with the sets of data, based on statistics associated with the sets of data, based on correlations among the sets of data, and/or based on a combination of data from multiple data stores. In some instances, the output information may be output from the machine. In certain instances the output information may not be output, but is used in other processes internal to the machine.

At 730, it may be determined whether the machine is configured to perform other operations consistent with a device operating with information-level intelligence. By way of example, it may be determined whether the machine is configured to perform one or more of the following operations: identifying trends in the data and output information associated with the trends, identifying statistics associated with data retrieved from one or more data stores and using those statistics to generate information, correlating data across the data store, determining correlations among the elements in the data store, predicting data that would be measured for a system that interpolates between states of the system for which data has been collected, and/or combining data from more than one database. In the event the machine is configured to perform a requisite operation(s) consistent with information-level intelligence, the process proceeds to step 740. In the event the machine is not configured to perform one or more operations consistent with information-level intelligence, the process ends and it is determined that the machine does not operate with information-level intelligence.

At 740, it is determined that the machine includes information-level intelligence. Upon a determination that a machine includes information-level intelligence, the machine may be evaluated for knowlege-level and/or other levels of intelligence.

FIG. 8 is a block diagram illustrating a process for determining that a machine includes knowledge-level intelligence according to embodiments of the present invention.

Wisdom may include an abstraction of knowledge, which is itself an abstraction of information, which is itself an abstraction of data. Wisdom may involve a functional model whose elements are bodies of knowledge, which is to say a model of models. The first-order models are the elements of knowledge; the model that assembles those models is a second-order, or meta-model, with far greater predictive power. As with knowledge, a meta-model should be able to extrapolate beyond the previously observed experiences. Meta-models, however, allow for “what-if” experiments, and thus wisdom goes beyond extrapolation. Wisdom comes from sufficiently broad bodies of knowledge such that we might be able to postulate changes. Those changes might suggest we could influence or modify the generation of data or information through manipulation of a manageable set of input parameters, and through wisdom, understand the likely impact.

In various embodiments, wisdom may involves one or more meta-models and/or invoke multiple knowledge-based models to provide sophisticated simulations and explanations of behavior. Wisdom level intelligence may use multiple models, and further extrapolation to events that are not included in the information base. A meta-model may involve positing a sequence of events and predicting the resulting data outputs. Wisdom may involves the notion that the observer can control the outcome by manipulating events. Wisdom may include a most dynamic level of intelligence. It cannot only adapt multiple models, but it can create entirely new ones to be tested and incorporated into the meta-model.

In wisdom, the causation models are bound to the meta-model at prediction time, which is to say that if one of the models changes, then the result of the meta-model changes. The meta-model, which may include wisdom, uses knowledge models in such a way that if the knowledge models are dynamically updated or envisioned as different models, then the meta-model automatically uses the updated model. The meta-model can consider what we might term as “alternate realities.”

For a machine, in order for wisdom to be used to influence outcomes, there is a separation of the input variables of the final program into variables that are observed, and variables that can be controlled. Further, the variables might have a time sequencing requirement, or specific time differentials that are specified and intended. In wisdom, a machine's predictive capabilities are used to seek goals by manipulating the controllable variables in order to obtain desirable predicted results.

In a system operating at wisdom level, the first-order models may include elements of knowledge; the meta-model that assembles those models is a second-order, with greater predictive power and an ability to speculate on alternative first-order models. Wisdom level intelligence may also include meta-meta models, or third order (or higher) models that are built on top of lower-order models. In this way, wisdom itself can have multiple discrete levels of intelligence. For clarity of explanation, all such levels into a single category of “wisdom.”

In process 800, a system for determining machine intelligence (for example, system 100 of FIG. 1) may verify that a machine 810 operates at knowledge-level intelligence. According to some embodiments, knowledge-level intelligence is found in a machine 810 that uses input information 820 associated with a system to produce a model 840 to explain how the system works. The model 840 may describe and/or explain any aspect of a system, such as the system's functionality. The system may include a particular domain and/or may describe a person, a group, an organization, a society, a physical system, a set of objects, natural phenomena, and/or any other subject matter. In one example, the system may be separate from the system evaluating machine intelligence (e.g., system 100 of FIG. 1). The model 840 may include machine-developed explanations of causality and/or structure associated with the system. In certain cases, the model 840 includes a predictor 850 that is able to provide output information 870 associated with a system given system state information 860 (e.g., information regarding a state of the system). The model 840 including the predictor 850 may comprise knowledge regarding the system.

It may be determined whether the machine 810 is configured to generate a model 840 that includes a prediction capability about a system, given that machine 810 has access to input information 820 associated with the system. In certain cases, the model 840 may go beyond implementing the trends that are inherent in the input information 820 associated with the system. The model 840 should be able to predict behavior(s) of the system in situations that extrapolate (as opposed to interpolate) from the observed behavior inherent in the input information 820. It may be determined, for example, that the model 840 and/or predictor 850 can extrapolate from the input information 820, by verifying that for certain states 860, the information that is provided about the system falls outside the range of input information 820 provided to the machine 810.

According to some embodiments, it may be determined that the model 840 and its structures, such as the predictor 850, are generated automatically by the machine 810. It may also be determined that attributes of the model 840 and/or predictor 850 are dependent on the input information 820 that the machine 810 is configured to ingest rather than user input. In certain cases, this may be verified by adjusting the input information 820 and evaluating resulting changes to the model 840. For example, modified input information 820 associated with a system may be provided to the machine 810, and the model 840 (and in certain cases the predictor 850) are evaluated to determine whether the model 840 is based on and/or takes into account the modified input information 820.

In some embodiments, it may not necessarily be determined how well the machine 810 produces knowledge (such as models 840 and/or associated predictors 850) based on input information 820 associated with a system. A model 840 may be good, or it may be poor, and that will be determined based on experience with using the machine 810. The techniques for determining machine intelligence may focus, rather, on determining whether the machine 810 is operating at the knowledge level, by verifying that the machine 810 can build a model 840 with predictive capabilities. Similar to the scientific method, wherein hypotheses must be verified through experimental processes, determining the extrapolative power of the model(s) 840 generated by machine 810 may be evaluated over time and may be independent of a determination that the machine is operating at a particular level of intelligence.

In some embodiments, each operation a machine 810 is capable of performing may be associated with a score, and if the score associated with the machine 810 is above a threshold, it is determined that the machine operates at a knowledge level. For example, a determination that the machine 810 is configured to receive (ingest) and/or build input information 820 about a system may equate to 20 points; a determination that the machine 810 is configured to generate a model 840 of the system, such that the model 840 depends on the input information 820 may equate to 20 points; a determination that the model 840 includes a model of causality that explains how the system works and/or evolves in response to input information 820 may equate to 10 points; a determination that the model 840 provides predictions of information 870 about the system that it models may equate to 10 points; a determination that the model 840 includes a set of values that correspond to a notion of the state of the system that is being modeled may equate to 10 points; a determination that the model 840 explains at least a portion (e.g., most of) the input information 820 that is provided about the system may equate to 10 points; a determination that the model 840 permits the prediction of information that extrapolates from the observed behavior of the system on which the input information 820 was based may equate to 10 points; a determination that the model 840 provides information 870 about the structure of the system, including elements that cannot be directly observed and are not part of the input information 820 may equate to 5 points; and a determination that the machine 810 is configured to generate models 840 describing different systems, based on input information about each such system may equate to 5 points. If the machine 810, for example, scores 80 points or higher, then the machine 810 may be determined to be at least a knowledge-level system.

FIG. 9 is a flowchart illustrating embodiments of a process for determining that a machine includes knowledge-level intelligence according to embodiments of the present invention. In various embodiments, process 900 may be implemented by system 100 of FIG. 1. The process 900 may be used to determine whether a machine includes and/or operates with knowledge-level intelligence.

At 910, it is determined that a machine is configured to receive information associated with a system. The information associated with the system may include any type of information describing, related to, used within, and/or otherwise associate with a system. The information associated with the system may be received from and/or derived from any of one or more bodies of information available to the machine.

At 920, it is determined whether the machine generates and/or is configured to generate a model base on the information associated with the system. The model may represent and/or describe functional aspects. In certain cases, the model may include a state space and/or a prediction function. In certain cases, the state space includes a structure including numerical or contextual data representing the system. The state space may include a set of variables describing and/or representing the system. The state space may include explanations of causality and/or structure of the system. In some embodiments, it may be determined whether the machine is configured to generate models describing different systems, based on input information about each such system. In the event the machine is configured to generate models based on information associated with a system, the process proceeds to step 930. In the event the machine is not configured to generate models based on information associated with a system, the process ends, and it is determined that the machine does not operate with knowledge-level intelligence.

At 930, it is determined whether the model is configured to predict behavior(s) of the system based on a state of the system. It may be determined whether the model includes a predictor and/or predictive functionality. In certain cases, it is determined whether the model and/or associated predictive functionality goes beyond implementing the trends that are inherent in received input information associated with the system. The model should be able to predict the behavior of the system in situations that extrapolate (as opposed to interpolate) from the observed behavior inherent in the input information associated with the system. It may be determined, for example, that the predictor can extrapolate from the input information, by verifying that for certain states, the information that is provided about the system falls outside the range of input information provided to the machine. In the event the model is configured to predict behavior(s) of a system based on the state of the system, the process proceeds to step 940. In the event the model is not configured to predict behavior(s) of a system based on the state of the system, the process ends and it is determined that the machine does not operate with knowledge-level intelligence.

At 940, it may be determined whether the model includes one or more attributes consistent with a device operating with knowledge-level intelligence. By way of example, it may be determined whether the model includes one or more of the following attributes: the model includes a set of values that correspond to a notion of the state of the system that is being modeled, the model explains at least a portion (e.g., most of) the input information that is provided about the system, the model permits the prediction of information that extrapolates from the observed behavior of the system on which the input information was based, and the model provides information about the structure of the system (including elements that cannot be directly observed and are not part of the input information). In the event it is determined that the model includes one or more requisite attributes consistent with knowledge-level intelligence, the process proceeds to step 950. In the event it is determined that the model does not include the requisite attributes consistent with knowledge-level intelligence, the process ends and it is determined that the machine does not operate with knowledge-level intelligence.

At 950, it is determined that the machine includes knowledge-level intelligence. Upon a determination that a machine includes knowledge-level intelligence, the machine may be evaluated for wisdom-level and/or other levels of intelligence.

FIG. 10 is a block diagram illustrating a process for determining that a machine includes wisdom-level intelligence according to embodiments of the present invention. In process 1000, a system for determining machine intelligence (for example, system 100 of FIG. 1) may verify that a machine 1010 operates at wisdom-level intelligence.

In some embodiments, it is determined whether a machine 1010 is operating at a wisdom-level of intelligence. To make this determination, it may be determined whether the machine 1010 is configured to use one or more models 1020, 1022, 1024 of a system and/or set of subsystems, and combines those models to produce a meta-model 1030. In certain cases, the meta-model 1030 may be used by the machine 1010 to execute experiments, such as “what-if” and/or hypothetical experiments, to predict attributes of hypothetical systems (e.g., systems that have not existed).

According to some embodiments, it is determined whether the machine 1010 is configured to “imagine” different knowledge models 1020, 1022, 1024 as inputs to the meta-model 1030 thereby producing different predictions of outcomes for given circumstances. A machine 1010 operating at wisdom-level intelligence may, in some cases, generate (instantiate) different input models 1020, 1022, 1024 to the meta-model, for the purpose of what-if analyses. The wisdom of the machine 1010 may be represented by how the models 1020, 1022, 1024 are combined; wisdom may, for example, be exercised when the machine 1010 considers the possibility of different systems with different knowledge models. Often, this will be for the purpose of devising alternative systems to be able to influence outcomes. A machine 1010 may operate at a wisdom level of intelligence if it can create a meta-model 1030 that has been developed from knowledge models 1020, 1022, 1024, and uses those knowledge models 1020, 1022, 1024 as inputs to exercise the meta-model 1030, and further can vary those inputs to explore alternative systems.

In some embodiments, to determine whether a machine 1010 is operating at a wisdom level of intelligence, it is determined whether machine 1010 matches a pattern that multiple bodies of knowledge. Each body of knowledge may include a model 1020, 1022, 1024 including a predictor that produces information about a system (or subsystem) given a state variable, and then combines those models to build a resulting meta-model 1030 (e.g., a “wisdom” model) that includes a predictor 1040. The meta-model 1030, as opposed to a knowledge model 1020, 1022, 1024, may enable the machine 1010 to perform hypothetical experiments (e.g., “what-if” experiments) by modifying the input knowledge models 1020, 1022, 1024. Thus to determine that the machine 1010 is operating at the wisdom level, it may be determined whether the machine 1010 is configured to change the ingested knowledge models 1020, 1022, 1024. In FIG. 10, the machine's 1010 ability to modify the knowledge models 1020, 1022, 1024 is depicted by the double-ended arrows between the machine 1010 and the input knowledge models 1020, 1022, 1024.

In some embodiments, a machine 1010 operating with wisdom-level intelligence is configured to “imagine” different knowledge models 1020, 1022, 1024 as inputs that produce different predictions of outcomes (from the meta-model 1030 and/or meta-model predictor 104) for given circumstances. The machine 1010 may generate (instantiate) different input models 1020, 1022, 1024 to the meta-model 1030, for the purpose of what-if analyses of potential alternatives. In certain cases, wisdom is represented by one or more of: how the models 1020, 1022, 1024 are combined and/or whether the 1010 machine considers the possibility of different systems with different knowledge models 1020, 1022, 1024. In certain cases, the machine 1010 is at the wisdom level of intelligence if it can create a meta-model 1030 that has been developed from knowledge models 1020, 1022, 1024, uses those knowledge models 1020, 1022, 1024 as inputs to exercise the meta-model 1030, and/or is configured to vary the inputs to explore alternative systems.

In some embodiments, each operation a machine 1010 is capable of performing that is relevant to wisdom-level performance may be associated with a score, and if the score associated with the machine 1010 is above a threshold, it is determined that the machine operates at a wisdom level. For example, a determination that the machine 1010 is configured to ingest multiple models 1020, 1022, 1024 that model a compound system, where each one models either all or part of the system (e.g., a subsystem) may equate to 20 points; a determination that the machine 1010 is configured to generate a meta-model 1030 of a system that varies if any of the ingested models 1020, 1022, 1024 varies may equate to 20 points; a determination that the machine 1010 is configured to change one or more of the ingested models 1020, 1022, 1024 to change the output meta-model 1030 (e.g., in a what-if experiment) may equate to 10 points; a determination that the machine 1010 is configured to use the meta-model 1030 to explore possible states of the modeled system, under various hypothetical circumstances (states) may equate to 10 points; a determination that the machine 1010 is configured to use the meta-model 1030 to explore possible states of the modeled system by varying ingested models 1020, 1022, 1024 may equate to 10 points; a determination that the machine 1010 is configured to use the meta-model 1030 to explore possible states and/or to attempt to maximize a metric applied to the information provided by the meta-model 1030 may equate to 10 points; a determination that the machine 1010 is configured to provide information about how the system might be changed so as to provide different (and better) states, according to some metric may equate to 10 points; and a determination that the machine 1010 is configured to provide actionable information actionable, in that controllable parameters of the system could be changed so as to conform to the different and better state of the system, as predicted by the meta-model 1030 may equate to 10 points. If the machine 1010, for example, scores 80 points or higher, then the machine 1010 may be determined to be at least a wisdom-level system.

FIG. 11 is a flowchart illustrating a process for determining that a machine includes wisdom-level intelligence according to embodiments of the present invention. In various embodiments, process 1100 may be implemented by system 100 of FIG. 1. The process 1100 may be used to determine whether a machine includes and/or operates with wisdom-level intelligence.

At 1110, it is determined that the machine is configured to receive (ingest) a plurality of models. The models may include models generated by a machine as discussed in relation to FIG. 8 and FIG. 9 above. In some cases, each of the models is associated with sub-system included in a compound system. The models may each be configured to predict a behavior of the sub-system based at least in part on a state of the sub-system. In another example, the models are each is associated with separate unrelated systems.

At 1120, it is determined whether the machine is configured to generate a meta-model based on the plurality of models. In the case where each of the models is associated with a sub-system of a compound system, the meta-model may be associated with the compound system as a whole and/or aspects of the compound systems. It may be determined whether the meta-model is configured to predict behaviors of the compound system and/or to explore possible states of the modeled compound system, under various hypothetical circumstances. In the event it is determined that the machine is configured to generate a meta-model based on the plurality of models, the process proceeds to step 1130. In the event it is determined that the machine is not configured to generate a meta-model based on the plurality of models, the process may end and it may be determined that the machine does not include wisdom-level intelligence.

At 1130, it is determined whether the machine is configured to change the meta-model by modifying the one or more of the plurality of models. In certain cases, the machine may be evaluated to determine whether it is configured to alter one or more the ingested models to change the output of the meta-model. The machine may, for example, alter models associated with sub-systems of a compound system to evaluate the effect of the alteration on the compound system represented by the meta-model. In this case, the machine may be performing “what if” prediction operations, which are consistent with a machine operating at wisdom-level intelligence. In the event it is determined the machine is configured to change the meta-model by modifying the one or more of the plurality of models, the process may proceed to step 1140. In the event it is determined the machine is not configured to change the meta-model by modifying the one or more of the plurality of models, the process may end and it may be determined that the machine does not include wisdom-level intelligence.

At 1140, it may be determined whether the machine is configured to perform one or more operations consistent with wisdom-level intelligence. By way of example, it may be determined whether the machine is configured to perform one or more of the following operations: use the meta-model to explore possible states of the modeled system, under various hypothetical circumstances (states), evaluate possible states of the modeled system by varying ingested models, use the meta-model to explore possible states and/or to attempt to maximize a metric applied to the information provided by the meta-model, provide information about how the system might be changed so as to provide different (and better) states, according to some metric, and provide actionable information actionable, in that controllable parameters of the system could be changed so as to conform to the different and better state of the system, as predicted by the meta-model. In the event it is determined that the machine is configured to perform one or more operations consistent with wisdom-level intelligence, the process proceeds to step 1150. In the event it is determined that the machine is not configured to perform one or more operations consistent with wisdom-level intelligence, the process ends and it is determined that the machine does not operate with wisdom-level intelligence.

At 1150, it is determined that the machine includes knowledge-level intelligence. Upon a determination that a machine includes knowledge-level intelligence, the machine may be evaluated for wisdom-level and/or other levels of intelligence.

In various embodiments, the techniques disclosed herein be used to guide future developments to achieve increased levels of intelligence in computing devices, and to provide a verifiable mechanism to determine that machine has attained a particular level of intelligence.

The present invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques or approaches. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A method of determining machine intelligence, comprising:
evaluating, via an interface with a machine, input information provided to the machine;
evaluating, via the interface with the machine, one or more operations automatically performed by the machine based on the input information; and
determining a level of intelligence associated with the machine based at least in part on the evaluation of the input information and the operations performed by the machine.

2. The method of claim 1, wherein the interface comprises a compiler-based interface to the machine.

3. The method of claim 1, wherein determining the level of intelligence comprises determining that the machine includes one or more of data-level intelligence, information-level intelligence, knowledge-level intelligence, and wisdom-level intelligence.

4. The method of claim 1, wherein evaluating the input information comprises determining that the input information comprises data.

5. The method of claim 4, wherein evaluating the operations comprises determining that the machine automatically stores the data in memory.

6. The method of claim 5, wherein determining the level of intelligence comprises determining that the machine includes data level intelligence based at least in part on one or more of the determination that the input information comprises data and the determination that the machine automatically stores the data in memory.

7. The method of claim 1, wherein evaluating the input information comprises determining that the machine is configured to receive input information comprising one or more queries to the machine.

8. The method of claim 7, wherein evaluating the operations comprises determining that the machine:
retrieves two or more distinct sets of information from memory; and
generates output based at least in part on the input information and two or more distinct sets of information retrieved from memory.

9. The method of claim 8, wherein determining the level of machine intelligence comprises determining that the machine includes information level intelligence based at least in part on the determination that the machine generates output based at least in part on the input information and the distinct sets of information.

10. The method of claim 1, wherein the input information comprises input information associated with a system.

11. The method of claim 10, wherein evaluating the operations comprises determining that the machine automatically generates a model based at least in part on the information associated with the system.

12. The method of claim 11, further comprising determining that the model is configured to predict a behavior of the system based at least in part on state information associated with the system.

13. The method of claim 12, wherein the predicted behavior is not included in information associated with the machine.

14. The method of claim 12, wherein determining the level of machine intelligence comprises determining that the machine includes knowledge level intelligence based at least in part on the determination that the model is configured to predict the behavior of the system.

15. The method of claim 1, wherein the input information comprises a plurality of models, each of the models configured to predict a behavior of a system based at least in part on state information associated with the system.

16. The method of claim 15, wherein evaluating the operations comprises determining that the machine is configured to generate a meta-model based at least in part on the plurality of models.

17. The method of claim 16, wherein the each of the plurality of models is associated with a sub-system included in a compound system and the meta-model is associated with the compound system.

18. The method of claim 16, wherein evaluating the operations further comprises determining that the machine is configured to change the meta-model by modifying the one or more of the plurality of models.

19. A computer-implemented system for determining machine intelligence, the system comprising:
a processor; and
a memory coupled with the processor, wherein the memory is configured to provide the processor with instructions which when executed cause the processor to:
evaluate, via an interface with a machine, input information provided to the machine;
evaluate, via the interface with the machine, one or more operations automatically performed by the machine based on the input information; and
determine a level of intelligence associated with the machine based at least in part on the evaluation of the input information and the operations performed by the machine.

20. One or more tangible non-transitory computer-readable storage media for storing computer-executable instructions executable by processing logic, the media storing one or more instructions to:
evaluate, via an interface with a machine, input information provided to the machine;
evaluate, via the interface with the machine, one or more operations automatically performed by the machine based on the input information; and
determine a level of intelligence associated with the machine based at least in part on the evaluation of the input information and the operations performed by the machine.
